(19) United States
(12) Patent Application Publication
(10) Pub. No.: US 2004/0159547 A1
(43) Pub. Date: Aug. 19, 2004

(54) Gas concentration detector

(75) Inventors: Hiroshi Haraguchi, Kariya-city (JP); Takashi Kojima, Kasugai-city (JP); Daisuke Kojima, Nagoya-city (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref (JP)

(21) Appl. No.: 10/761,191

(22) Filed: Jan. 22, 2004

(30) Foreign Application Priority Data
Feb. 17, 2003 (JP) 2003-38004

(51) Int. Cl. G01N 27/26

(52) U.S. Cl. 204/424; 204/426

(57) ABSTRACT

A sensor element of a NOx sensor has a sensor cell for decomposing NOx and residual O₂ admitted within the element and a monitor cell for decomposing only the residual O₂. The NOx concentration is detected from a difference in an electric current output between the sensor cell and monitor cell. The tipping of the sensor element is protected by an element cover. The element cover has a plurality of side wall holes and at least one bottom wall hole. The side wall holes and bottom wall hole have diameters between 0.5 and 1.5 mm. A ratio of the diameter of the side wall holes to that of the bottom wall hole is between 0.5 and 1.5. This structure inhibits flow velocity variations within the element cover and output pulsation of the sensor cell and monitor cell, resulting in stabilizing the NOx output.

### CROSS REFERENCE TO RELATED APPLICATIONS

This application is based on and incorporates herein by reference Japanese Patent Application No. 2003-38004 filed on Feb. 17, 2003.

### FIELD OF THE INVENTION

The present invention relates to a gas concentration detector detecting, using a plurality of cells formed on a solid electrolyte element, a concentration of given gas in measurement gasses, e.g., a NOx concentration in exhaust gasses from an internal combustion engine of an automobile. In detail, it relates to a structure of an element cover of the gas concentration detector for enhancing detection accuracy.

### BACKGROUND OF THE INVENTION

Nowadays, concerns about a global environment are growing, so that emission regulations to exhaust gasses from an internal combustion engine of an automobile become stricter every year. To deal with the regulations, more accurate controls for the exhaust gasses are highly expected. For instance, it is expected that a gas concentration detector directly detects a concentration of NOx as a harmful substance contained in the exhaust gasses to feed the detection result back to an EGR (Exhaust Gasses Re-circulation) system or a catalyzing system.

This gas concentration detector includes a known type that detects the NOx concentration with a plurality of cells formed on an oxygen-ion-conducting solid electrolyte element. Here, the NOx concentration is detected using a difference in activity to NOx reduction between the cells. This is disclosed in JP-A-H9-288086.

The above conventional gas concentration detector generally includes: a pump cell that discharges or pumps O₂ in the exhaust gasses admitted into a chamber; a monitor cell that generates an output according to an O₂ concentration remaining within the chamber; and a sensor cell that generates an output according to an O₂ and NOx concentrations remaining within the chamber. Here, the O₂ concentration within the chamber is detected in the monitor cell and maintained constant by feedback-controlling pump-cell voltage, while the NOx concentration is detected from current flowing in the sensor cell.

In this gas concentration detector, the chamber includes the first chamber having the pump cell and the second chamber having the sensor cell and monitor cell, the two chambers which are fluidly communicated via an orifice. This structure enables a variation of the O₂ concentration near the sensor and monitor cells to decrease; however, a variation of the O₂ concentration within the first chamber due to a variation of the pump-cell voltage cannot be directly reflected in the O₂ concentration within the second chamber or the monitor-cell current. The O₂ concentration within the second chamber is thereby liable to fluctuate. Therefore, it is proposed that the NOx concentration in the exhaust gasses is detected from an output difference between the sensor cell and monitor cell. This enables the detected NOx concentration as a sensor output to be independent of the O₂ concentration within the second chamber, resulting in enhancement of detection accuracy.

In another aspect, the sensor and monitor cells have different reactivity or response to oxygen since their chamber-facing electrodes use different types of material such as Pt—Rh being active in decomposing the NOx and Pt—Au being inactive, respectively. It is because the sensor cell electrode including Rh is apt to store oxygen to more easily pump O₂ within the chamber than the monitor cell electrode, resulting in slow response to a variation of the O₂ concentration. A variation of the output difference between the sensor and monitor cells is thereby generated even when an engine's operating state varies, or even when the residual O₂ concentration slightly varies. As a result, the variation of the output difference between the sensor and monitor cells leads to a variation of the detected NOx value, which results in incapability of accurate NOx detection.

### SUMMARY OF THE INVENTION

It is an object of the present invention to provide a gas concentration detector capable of inhibiting variations of output due to a material difference between electrodes used in the detector, and of accurately detecting given gas in measurement gasses such as NOx in the exhaust gasses.

To achieve the above object, a gas concentration detector is provided with the following. The gas concentration detector is provided in a space for measuring a concentration of given gas contained in measurement gasses existing within the space. The gas concentration detector comprises a sensor element and an element cover. The sensor element includes a sensor cell and a monitor cell. The sensor cell is for detecting the concentration of the given gas contained in the measurement gasses that are admitted into a chamber within the sensor element. The monitor cell is for detecting an O₂ concentration within the chamber. The element cover is a cylinder having a bottom, to surround the sensor element. The element cover has a gas inlet hole through which the measurement gasses flow. The gas inlet hole includes a plurality of side wall holes and at least one bottom wall hole. Here, diameters of the side wall holes and the bottom wall hole are within a range between 0.5 and 1.5 mm, while a ratio of the diameter of the side wall holes to the diameter of the bottom wall hole is within a range between 0.5 and 1.5.

This invention focuses attention on that a difference of outputs of the sensor and monitor cells are affected and varied by gas flow within the element cover. It is found that the above structure of the element cover of the present invention can inhibit the output difference between the cells. Namely, the above structure inhibits a variation in a flow velocity of the measurement gasses within the element cover to reduce the output pulsation width of the sensor and monitor cells, enhancing detection accuracy.

### BRIEF DESCRIPTION OF THE DRAWINGS

The above and other objects, features, and advantages of the present invention will become more apparent from the following detailed description made with reference to the accompanying drawings. In the drawings:

FIG. 1A is a sectional view showing a structure of an element cover as a main part of a gas concentration detector according to a first embodiment of the present invention;

FIGS. 1B, 1C are horizontal sectional views of the element cover taken along Line A-A in FIG. 1A;

FIG. 1D is an underside view of the element cover;

FIG. 2A is a view showing an overall structure of the gas concentration detector according to the first embodiment;

FIG. 2B is an enlarged schematic sectional view showing a tipping end of a sensor element taken from Circle C in FIG. 2A;

FIG. 3 is a schematic view showing an overall structure of an internal combustion engine including a gas concentration detector of the present invention;

FIG. 4 is a graph showing NOx output pulsation width and NOx response time relative to hole diameters in the gas concentration detector according to the first embodiment;

FIG. 5 is a graph showing NOx output pulsation width relative to a diameter ratio of the side and bottom wall holes in the gas concentration detector according to the first embodiment;

FIG. 6A is a sectional view showing a structure of an element cover as a main part of a gas concentration detector according to a second embodiment of the present invention;

FIGS. 6B, 6C are horizontal sectional views of the element cover taken along Line A-A or B-B in FIG. 6A;

FIG. 6D is an underside view of an outer cover of the element cover;

FIG. 6E is an underside view of an inner cover of the element cover;

FIGS. 7A to 7C are graphs showing monitor-cell current, sensor-cell current, and NOx output, prior or posterior to a countermeasure in the element cover of the present invention;

FIG. 8A is a schematic sectional view of a tipping end of a sensor element of a gas concentration detector according to a third embodiment of the present invention;

FIG. 8B is a sectional view taken along Line D-D in FIG. 8A;

FIG. 9 is a schematic sectional view of a tipping end of a sensor element of a gas concentration detector according to a fourth embodiment of the present invention; and

FIG. 10 is a schematic sectional view of a tipping end of a sensor element of a gas concentration detector according to a fifth embodiment of the present invention.

### DETAILED DESCRIPTION OF THE PREFERRED EMBODIMENTS

### First embodiment

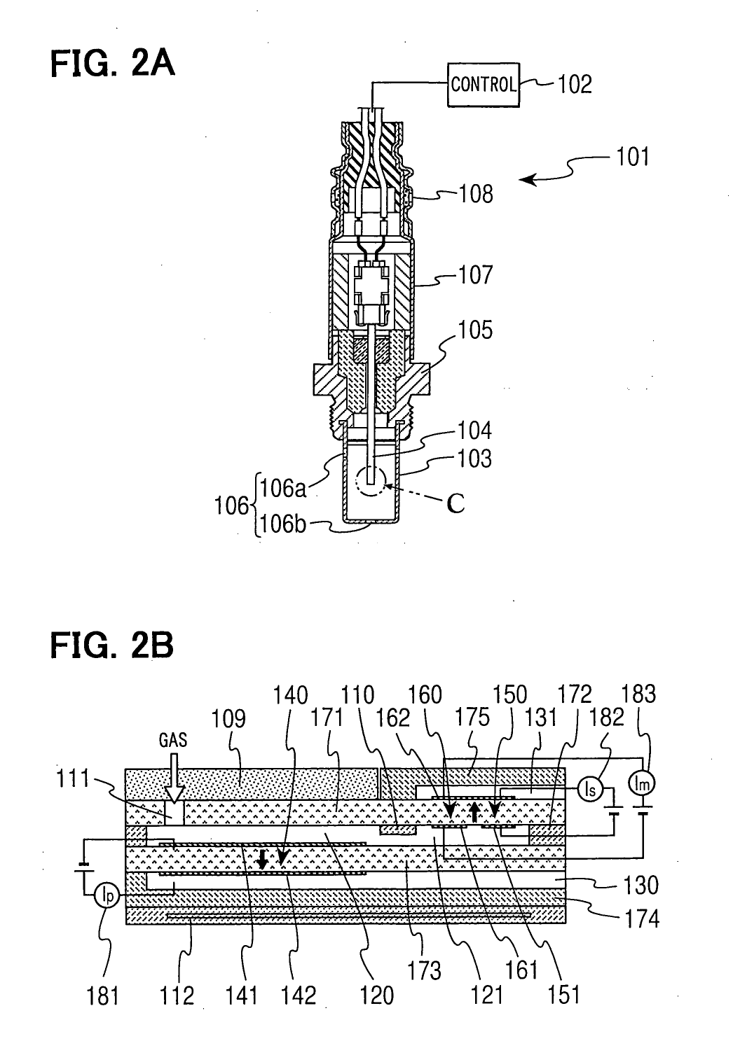

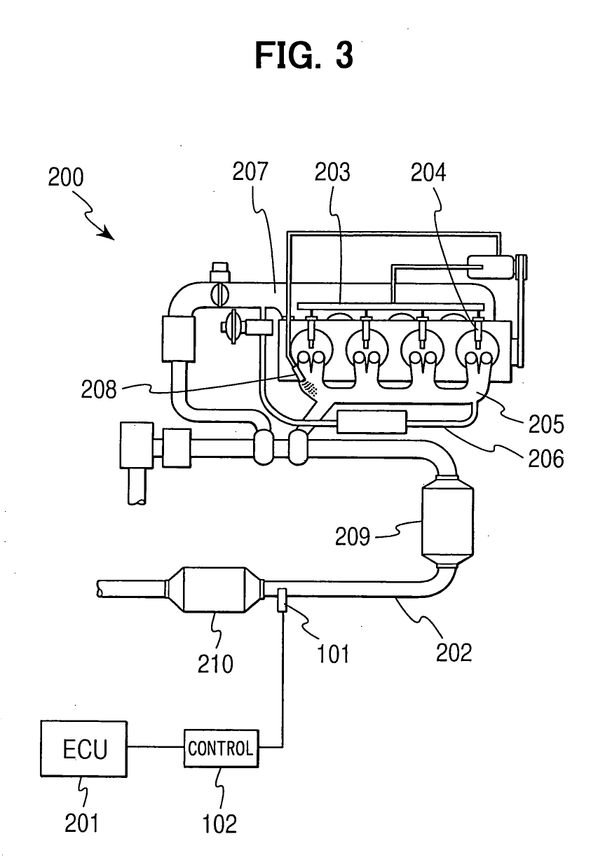

A gas concentration detector of a first embodiment of the present invention includes a NOx sensor 101 and a control circuit 102 as shown in FIG. 2A. For instance, the gas concentration detector is disposed in an exhaust pipe 202 in an internal combustion engine (diesel engine) 200 for detecting given constituent gas (NOx) in measurement gasses (exhaust gasses) as shown in FIG. 3. The internal combustion engine 200 is constructed with a common rail 203 to inject high-pressure fuel accumulated in the common rail 203 into the corresponding cylinders via the fuel injection valves 204. An EGR passage 206 intermediates between an exhaust manifold 205 and an intake manifold 207 to partially re-circulate the exhaust gasses to the intake.

The exhaust manifold 205 is followed by the exhaust pipe 202 equipped with a post-treatment unit 209 having a NOx storage/reduction type catalyst, and an oxidizing catalyst 210. The exhaust manifold 205 accommodates an exhaust fuel addition valve 208 for adding fuel as a reducing agent for NOx. The NOx sensor 101 is disposed upstream from the oxidizing catalyst 210 for importing the exhaust gasses passing through the NOx storage/reduction type catalyst. The control circuit 102 detects, based on signals from the NOx sensor 101, a NOx concentration to output it to an ECU 201. For instance, the ECU 201 diagnoses deterioration of the NOx storage/reduction type catalyst or feedback-controls the EGR system.

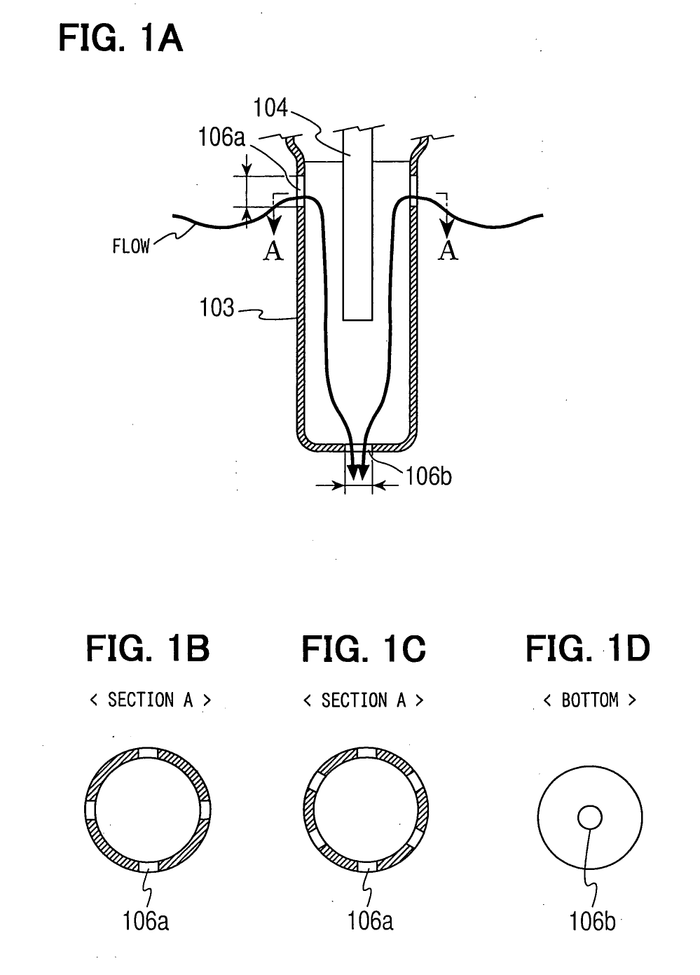

As shown in FIG. 2A, the NOx sensor 101 includes a housing 105, a sensor element 104, an element cover 103, and a cylindrical member 107. The housing 105 is fixed in a wall of the exhaust pipe 202 shown in FIG. 3. The sensor element 104 is supported in an insulating condition within the housing 105. A tipping end (lower end in FIG. 2A) of the sensor element 104 is contained within the element cover 103 that is fixed on the bottom end (lower end in FIG. 2A) of the housing 105 and protrudes into the exhaust pipe 202. The element cover 103 draws the exhaust gasses within the exhaust pipe 202 via a gas inlet hole 106 formed through side and bottom walls thereof. The cylindrical member 107 is fixed on the top end (upper end in FIG. 2A) of the housing 105 and has an atmosphere inlet hole 108 formed through a side wall thereof. As shown in FIG. 1A, the element cover 103 is a cylinder having a bottom, with the gas inlet hole 106 that includes a plurality of side wall holes 106a penetrating through the upper side wall and a bottom wall hole 106b penetrating through the center of the bottom wall. Dimensions and disposition of the gas inlet hole of the element cover 103 being features of the present invention will be described later.

The enlarged tipping end of the sensor element 104 is shown 2B. The sensor element 104 includes: a first and second chambers 120, 121 where the exhaust gasses are admitted; atmosphere ducts 130, 131 fluidly communicating with the atmosphere; a pump cell 140 in the first chamber 120; and a sensor cell 150 and monitor cell 160 in the second chamber 121. The sensor and monitor cells 150, 160 are aligned in a longitudinal direction of the sensor element 104 (in a lateral direction in FIG. 2B). The first chamber 120 fluidly communicates with the second chamber 121 via an orifice 110 to accept the exhaust gasses via a porous diffusion layer 109 and a pinhole 111.

The sensor element 101 is a multi-layered structure including (from top to bottom in FIG. 2B): the porous diffusion layer 109 and a spacer 175 constituting the atmosphere duct 131; a sheet-type solid electrolyte element 171 constituting the sensor cell 150 and the monitor cell 160; a spacer 172 constituting the first and second chambers 120, 121; a sheet-type solid electrolyte element 173 constituting the pump cell 140; a spacer 174 constituting the atmosphere duct 130; and a sheet-type heater 112. The solid electrolyte elements 171, 173 are formed of a solid electrolyte being oxygen-ion-conducting such as zirconia, while the spacers 172, 174, 175 are formed of insulating material such as alumina. The porous diffusion layer 109 is formed of, e.g., porous alumina.

The pump cell 140 is formed of the solid electrolyte element 173 and an opposing pair of electrodes 141, 142 containing the solid electrolyte element 173 therebetween. The pump cell 140 is for discharging or pumping oxygen into or from the atmosphere duct 130 to thereby control the O₂ concentration within the first chamber 120. Of the pair of electrodes 141, 142, the electrode 141 facing the first chamber 120 is an electrode being inactive in decomposing NOx, e.g., Pt—Au porous cermet electrode. By contrast, the electrode 142 facing the atmosphere duct 130 is, e.g., a Pt porous cermet electrode. The porous cermet electrode is formed by baking paste form of metal and ceramics such as alumina and zirconia.

The monitor cell 160 is formed of the solid electrolyte element 171 and an opposing pair of electrodes 161, 162 containing the solid electrolyte element 171 therebetween. The monitor cell 160 is for detecting, within the second chamber 121, the residual O₂ concentration admitted from the first chamber 120 via the orifice 110. Of the pair of electrodes 161, 162, the electrode 161 facing the second chamber 121 is an electrode being inactive in decomposing NOx, e.g., Pt—Au porous cermet electrode. By contrast, the electrode 162 facing the atmosphere duct 131 is, e.g., a Pt porous cermet electrode. When given voltage is applied between the electrodes 161, 162, a current output (monitor-cell current) Im is obtained based on the residual O₂ concentration.

The sensor cell 150 is formed of the solid electrolyte element 171 and an opposing pair of electrodes 151, 162 containing the solid electrolyte element 171 therebetween. The sensor cell 150 adjoins the monitor cell 160. Of the pair of electrodes 151, 162, the electrode 162 facing the atmosphere duct 131 is commonly used in the monitor cell 160. The sensor cell 150 is for detecting, within the second chamber 121, the NOx and residual O₂ concentrations admitted from the first chamber 120. Of the pair of electrodes 151, 162, the electrode 151 facing the second chamber 121 is an electrode being active in decomposing NOx, e.g., Pt—Rh porous cermet electrode. When given voltage is applied between the electrodes 151, 162, a current output (sensor-cell current) Is is obtained based on the NOx and residual O₂ concentrations.

The heater 112 is a sheet that is formed of insulating material such as alumina and contains a heater electrode. The heater electrode is heated by being supplied with electric current to maintain the cells 140, 150, 160 at an activation temperature or more by heating the entire element.

An operational principle of the above NOx sensor 101 will be explained below. In FIG. 2B, the exhaust gasses as measurement gasses are admitted into the first chamber 120 via the porous diffusion layer 109 and the pinhole 111. A flow amount of the admitted exhaust gasses depends on diffusion resistance of the porous diffusion layer 109 and pinhole 111. Here, when voltage is applied between the electrodes 141, 142 of the pump cell 140 with the electrode 142 facing the atmosphere duct 130 being positive, the O₂ is reduced and decomposed to become oxygen ions on the electrode 141 facing the first chamber 120. The oxygen ions are then emitted towards the electrode 142 by a pumping function (see an arrow within the pump cell 140). When the voltage is inversely applied, oxygen is inversely transferred from the atmosphere duct 130 to the first chamber 120.

The pump cell 140 thus discharges or pumps oxygen by adjusting magnitude and direction of the applied voltage using the oxygen pumping function to control an O₂ concentration within a chamber. Typically, to decrease effect of oxygen on detecting NOx, the oxygen within the first chamber 120 is discharged, so that the O₂ concentration within the second chamber 121 is maintained in a given low concentration. Here, the electrode 141 facing the first chamber 120 is inactive in decomposing the NOx, so that the NOx in the exhaust gasses is not decomposed by the pump cell 140.

In the embodiment, the pump cell 140 is controlled using an applied-voltage map previously specified according to pump-cell current Ip. The pump cell 140 has a limiting current characteristic with respect to an O₂ concentration. In a V-I characteristic figure indicating a relation between pump-cell applied-voltage Vp and pump-cell current Ip, the limiting current detection region is located in a linear portion approximately parallel with an axis of voltage. With increasing oxygen concentration, the voltage value increases. By variably controlling the pump-cell applied-voltage Vp according to the pump-cell current Ip, the oxygen admitted into the first chamber 120 is thereby rapidly discharged to maintain the first chamber 120 in a given low oxygen concentration. This leads to decrease the effect of the oxygen as interfering gas with respect to detecting the NOx being given constituent gas.

The exhaust gasses passing the pump cell 140 enter the second chamber 121 via the orifice 110. When voltage is applied between the electrodes 161, 162 of the monitor cell 160 with the electrode 162 facing the atmosphere duct 131 being positive, a slight amount of the residual O₂ concentration in the exhaust gasses is reduced and decomposed to become oxygen ions on the electrode 161 facing the second chamber 121. The oxygen ions are then emitted towards the electrode 162 by the pumping function (see an arrow under the electrode 162). The electrode 161 is inactive in decomposing NOx, so that the monitor-cell current Im measured by a current detector 183 is not dependent on the NOx concentration, but dependent on the oxygen reaching the second chamber 121. The residual O₂ concentration is thereby detected by detecting the monitor-cell current Im.

By contrast, with respect to the sensor cell 150, the electrode 151 facing the second chamber 121 is in active in decomposing NOx. When voltage is applied between the electrodes 151, 162 of the sensor cell 150 with the electrode 162 facing the atmosphere duct 131 being positive, the residual O₂ and NOx in the exhaust gasses are reduced and decomposed to become oxygen ions on the electrode 161 facing the second chamber 121. The oxygen ions are then emitted towards the electrode 162 by the pumping function (see the arrow under the electrode 162). The sensor-cell current Is measured by a current detector 182 is dependent on the O₂ and NOx reaching the second chamber 121. The monitor cell 160 and sensor cell 150 adjoin with each other, so that the O₂ concentration reaching the electrodes 151, 161 facing the second chamber 121 are almost the same. The NOx concentration can be thereby detected by deducting the monitor-cell current Im (corresponding to the oxygen concentration) from the sensor-cell current Is.

As explained above, the NOx concentration can be detected without depending on the oxygen amount within the chamber, using an output difference between the adjoining sensor and monitor cells 150, 160. However, the chamber-side electrode material difference between the sensor and monitor cells actually develops a difference in response to oxygen. Namely, the electrode 151 of the sensor cell 150 uses Pt—Rh, while the electrode 161 of the monitor cell 160 uses Pt—Au. In particular, Rh in the sensor cell 150 is apt to pump oxygen due to its oxygen storage characteristic, so that the electrode 151 exhibits a slow response to an oxygen variation. By contrast, the monitor cell 160 sensitively reacts to the oxygen variation due to, e.g., an oxygen concentration distribution within a chamber, resulting in easily generating output pulsation. This develops a problem that the NOx output being an output difference may thereby become unstable.

To deal with the above problem, the present invention inhibits a flow velocity variation of the exhaust gasses within the element cover 103 and a variation of the NOx output through devising a structure of the element cover 103.

In detail, the element cover 103 includes a plurality of side wall holes 106a and at least one bottom wall hole 106b. A diameter of the side wall holes 106a and a diameter of the bottom wall hole 103b are specified. Furthermore, a ratio of the diameter of the side wall holes 106a to that of the bottom wall hole 106b is also specified.

In this embodiment, as shown in FIG. 1A, the plurality of side wall holes 106a are disposed near the top end of the element cover 103, while the bottom wall hole 106b is disposed in the center portion of the bottom of the element cover 103. Here, a flow of measurement gasses is formed as indicated by an arrow shown in FIG. 1A. Thus, the side wall holes 106a are preferably disposed in the upper region than the tipping end of the sensor element 104 that is a detecting portion. The pinhole 111 accepting the exhaust gasses is located in one side of the tabular sensor element 104, so that the sensor element 104 has directionality as shown in FIG. 2B. To decrease the effect of the directionality, an axial flow (vertical flow in FIG. 1A) with respect to the detecting portion is basically preferred.

The plurality of side wall holes 106a are disposed, as shown in FIGS. 1A, 1B, 1C, in the approximately same circumferential line with respect to the element cover 103. Namely, the plurality of side wall holes are disposed along the intersecting circumferential line formed between the side wall of the element cover 103 and a virtual plane perpendicular to an axis of the sensor element 104 or element cover 103. For instance, as shown in FIG. 1B, four side wall holes 106a are disposed at the approximately same intervals. The number of side wall holes 106a is not limited to the certain number, but preferably four or six. When the number of side wall holes 106a is less than four, the NOx sensor 101 being installed in the exhaust pipe 202 has directionality with respect to the exhaust gasses flow. Response is thereby remarkably affected by the directions of the holes 106a. The number being not less than four cannot be affected by the directions. By contrast, the number of side wall holes 106a being more than six does not produce an additional advantage, but exhibits difficulty in manufacturing more than six holes because of being much close to the next. FIG. 1C shows an example of six side wall holes 106a. Here, since the plurality of side wall holes 106a are disposed in the same circumferential line with respect to the element cover 103 with the approximately same intervals, the directionality is not generated when the NOx sensor 101 is installed in the exhaust pipe 202.

The number of bottom wall hole 106a can be more than one; however, the number is preferably one at the center of the bottom of the element cover 103. The number of bottom wall hole 106b being only one makes manufacturing of the hole easy. This results in easily obtaining an advantage inhibiting a variation of a flow velocity within the element cover 103 based on specification of a hole diameter to be described later.

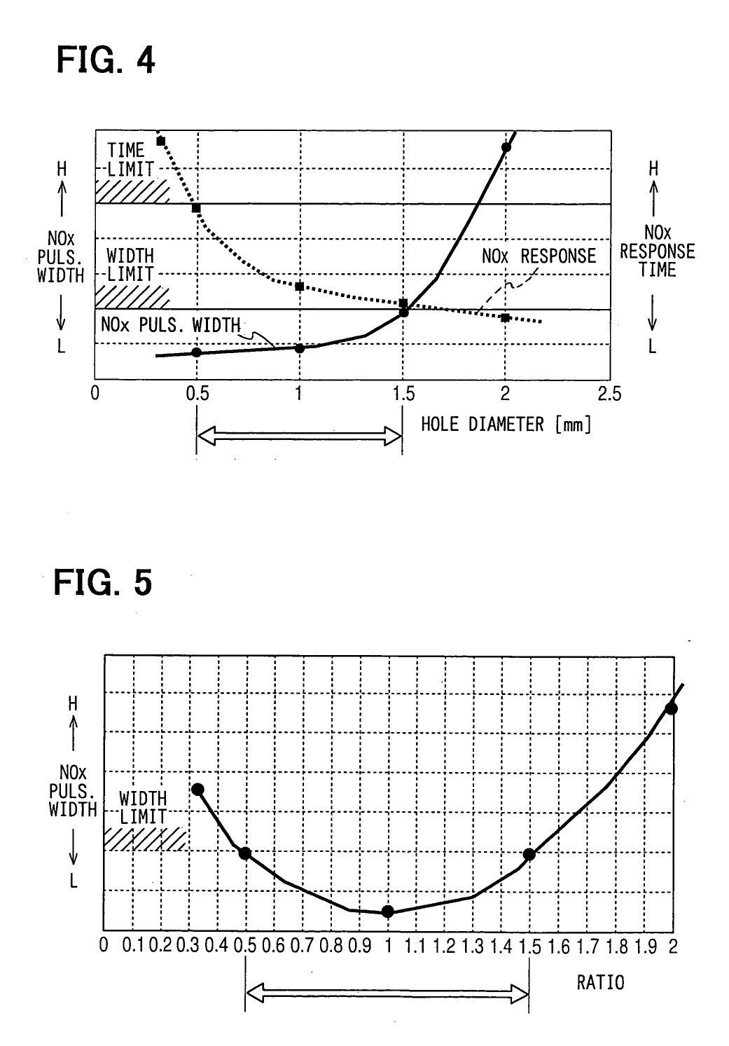

The diameters of the side wall holes 106a and bottom wall hole 106b of the element cover 103 will be explained below. FIG. 4 shows a relationship between the hole diameter and the output characteristic of the sensor element 104 when the element cover 103 has a structure shown in FIG. 1A with four side wall holes 106a and one bottom wall hole 106b. Here, a ratio of the diameter of side wall holes to that of the bottom wall hole 106b is maintained in the same and one. Namely, the diameters of the side wall holes 106a and the bottom wall hole 106b are the same common diameter. The common diameter (of the side wall holes 106a and bottom wall hole 106b) is varied from 0.3 to 2 mm. As shown in FIG. 4, with increasing common diameter, the response time decreases and the output pulsation width increases. In detail, when the common diameter is less than 0.5 mm, the response time is remarkably worsened. By contrast, when the common diameter is more than 1.5 mm, the pulsation width remarkably increases. FIG. 4 further shows limiting values for the output pulsation width and response time necessary for detecting NOx in the exhaust gasses with given detection accuracy. As a result, the common diameter being from 0.5 to 1.5 mm provides compatibility between the response time and pulsation width.

Next, the ratio of the diameter of side wall holes 106a to that of the bottom wall hole 106b will be explained below. FIG. 5 shows a NOx output pulsation width according to a ratio of hole diameters listed in Table 1 below when the element cover 103 has a structure shown in FIG. 1A with four side wall holes 106a and one bottom wall hole 106b. Here, a ratio of the hole diameters is [side wall hole diameter]/[bottom wall hole diameter].

TABLE 1

| | | | | | |
|---|---|---|---|---|---|
| A: SIDE WALL HOLE | φ 0.5 | φ 0.5 | φ 1 | φ 1.5 | φ 1.5 |
| DIAMETER (mm) | | | | | |
| B: BOTTOM WALL HOLE | φ 1.5 | φ 1 | φ 1 | φ 1 | φ 0.75 |
| DIAMETER (mm) | | | | | |
| RATIO OF HOLE | 0.33 | 0.5 | 1.0 | 1.5 | 2.0 |
| DIAMETERS: A/B | | | | | |

The output pulsation width is the narrowest at approximately 1.0 of the ratio, and increases either at the lower ratio or the higher ratio than 1.0 of the ratio. Accordingly, the ratio of hole diameters is preferably specified in a range from 0.5 to 1.5 based on the limiting value of the NOx output pulsation width shown in FIG. 5.

A conventional element cover of a gas sensor tends to have larger hole diameters (e.g., side wall hole: φ 2.5 mm, bottom wall hole: φ 2 mm) so as to obtain quick response by facilitating gas exchange between the outside and the inside of the element cover. However, the conventional element cover tends to undergo flow velocity variations. In such a NOx sensor where the sensor cell and monitor cell have different output responses, the output pulsation of a monitor cell thereby becomes larger than that of a sensor cell, resulting in variations in the NOx output. By contrast, the element cover 103 of the embodiment being specified with respect to the numbers and diameters of the holes inhibits flow velocity variations within the element cover 103. This leads to inhibiting the output pulsation of the sensor and monitor cells 150, 160 of the sensor element 104, resulting in enhancement of detection accuracy of the NOx output obtained from an output difference between the cells 150, 160.

### Second Embodiment

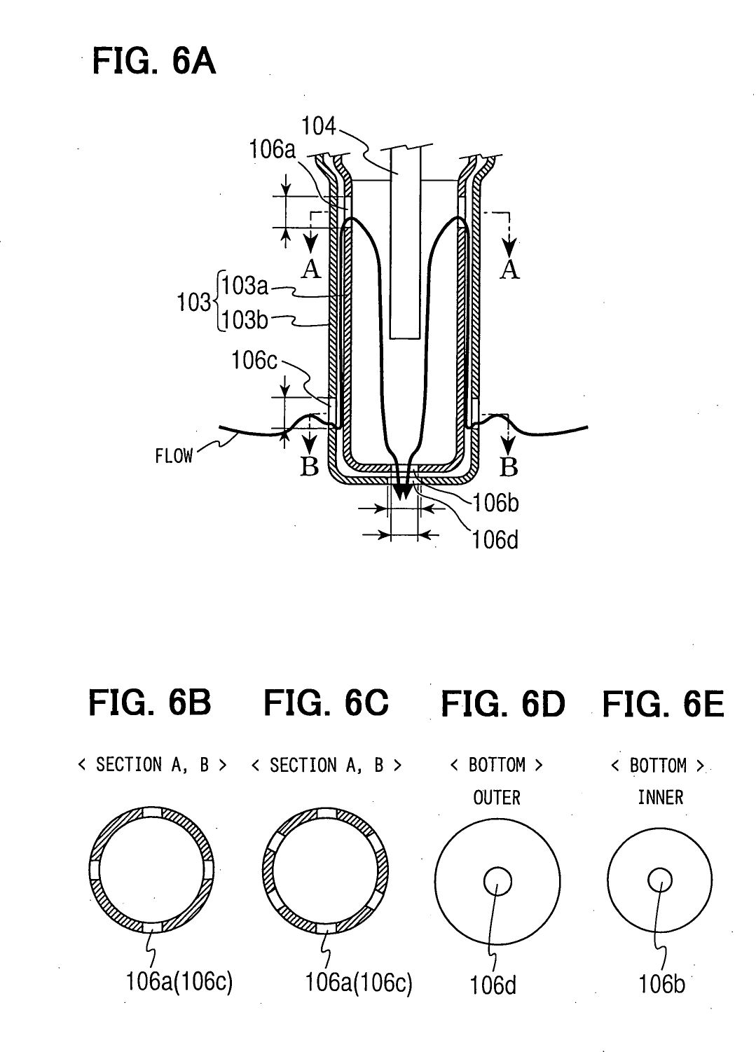

An element cover 103 of a gas concentration detector according to a second embodiment of the present invention has a double structure shown in FIG. 6A. The element cover 103 includes an inner cover 103a and an outer cover 103b surrounding the inner cover 103a. The inner cover 103a has the same structure as the element cover 103 according to the first embodiment, having a plurality of side wall holes 106a near the top end thereof and at least one bottom wall hole 106b. Similarly with the first embodiment, the diameter of the side wall holes 106a and the diameter of the bottom wall hole 106b fall in a range between 0.5 and 1.5 mm, while a ratio of the diameter of the side wall holes 106a to the diameter of the bottom wall hole 106b falls in a range between 0.5 to 1.5.

The outer cover 103b of a cylindrical shape having a bottom has a little longer diameter than the inner cover 103a, having a plurality of side wall holes 106c and at least bottom wall hole 106d. The plurality of side wall holes 106c are disposed at the side near the lower end, while the at least one bottom wall hole is disposed at the center of the bottom. The diameter of the bottom wall hole 106d of the outer cover 103b is preferably equivalent to or longer than the diameter of the bottom wall hole 106b of the inner cover 103a. The diameters of the side wall holes 106c of the outer cover 103b are preferably equivalent to or longer than the diameters of the side wall holes 106a of the inner cover 103a. In addition, the diameters of the holes 106c, 106d are preferable not less than any diameters of the holes 106a, 106b of the inner cover 103a. This structure does not prevent gas flow from reaching the inside of the inner cover 103a. This leads to obtaining the same effect as the first embodiment by further specifying, of the inner cover 103a, the diameters of the holes 106a, 106b and the ratio of the diameters of the holes 106a, 106b as described in the above. Disposing the plurality of side wall holes 106c of the outer cover 103b near the lower end of the outer cover 103b expects prevention of water attacking. When the side wall holes 106c of the outer cover 103b are disposed in a portion lower than the side wall holes 106a of the inner cover 103a, the gas flow shown in FIG. 6A travels upward within the outer cover 103b to inhibit water from entering the inside of the inner cover 103a.

The numbers of side wall holes 106a of the inner cover 103a and side wall holes 106c of the outer cover 103b are preferably four to six similarly with the first embodiment. FIGS. 6B, 6C show examples of element covers having four and six side wall holes, which are preferably disposed along the same circumferential line with respect to the element cover 103. The numbers of side wall holes 106a of the inner cover 103a and side wall holes 16c of the outer cover 103b are preferably the same. The numbers of bottom wall hole 106b of the inner cover 103a and bottom wall hole 106d of the outer cover 103b are preferable one at the centers of the bottoms shown in FIGS. 6D, 6E similarly with the first embodiment.

The basic operation of the NOx sensor 101 according to this embodiment is the same as that of the first embodiment. Furthermore, appropriately specifying the hole diameters and ratio of the hole diameters of the inner cover 103a and the hole diameters of the outer cover 103b inhibits water from damaging the NOx sensor 101. This leads to enhancement of NOx detection accuracy without deteriorating a response characteristic.

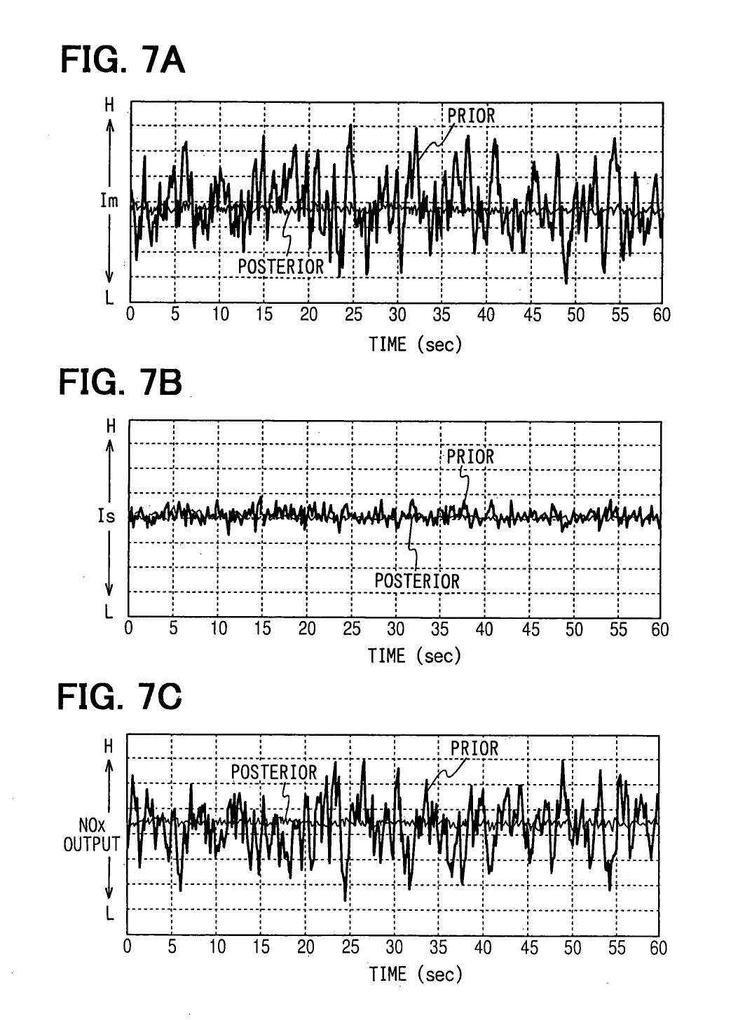

FIGS. 7A to 7C show effects of the second embodiment of the present invention in monitor-cell current Im, sensor-cell current Is, and NOx output (=Is−Im) of NOx detection tests using model gas with comparison between “prior to” and “posterior to” countermeasures. Here, “posterior to countermeasures” indicates the second embodiment as follows.

Inner cover 103a—side wall hole 106a: φ 1.0 mm×4

bottom wall hole 106b: φ 1.0 mm×1

Outer cover 103b—side wall hole 106a: φ 1.5 mm×4

bottom wall hole 106b: φ 1.5 mm×1

By contrast, “prior to countermeasures” indicates the conventional element cover as follows.

Inner cover—side wall hole: φ 2.5 mm×4

bottom wall hole: φ 2.0 mm×1

Outer cover—side wall hole: φ 2.5 mm×4

bottom wall hole: φ 2.0 mm×1

As shown in FIGS. 7A, 7B, the monitor-cell current Im prior to the countermeasure fluctuates (has a great deal of pulsation width) with respect to the sensor-cell current Is, leading to fluctuation in the NOx output shown in FIG. 7C. By contrast, the monitor-cell current Im posterior to the countermeasure, i.e., in a case where the element cover 103 is provided with the countermeasure of appropriately specifying the hole diameters and the ratio of the hole diameters, the pulsation width of the monitor-cell current is inhibited as shown in FIG. 7A. This enables the pulsation width of the NOx output being a difference between the sensor-cell current Is and monitor-cell current Im to be inhibited, leading to enhancement of detection accuracy for the NOx concentration.

As explained above, with respect to a NOx sensor 101 having different oxygen responses between a sensor cell 150 and a monitor cell 160, hole diameters and a ratio of the diameters of an element cover 103 are appropriately specified or optimized. This enables current output responses of the sensor and monitor cells 150, 160 to approximately accord, leading to enhancement of NOx detection accuracy. In particular, when it is directed to the embodiment where a detection value is an output difference between the sensor cell 150 and monitor cell 160, this invention is effective in offsetting a variation of the detection value due to a response difference.

### Third Embodiment

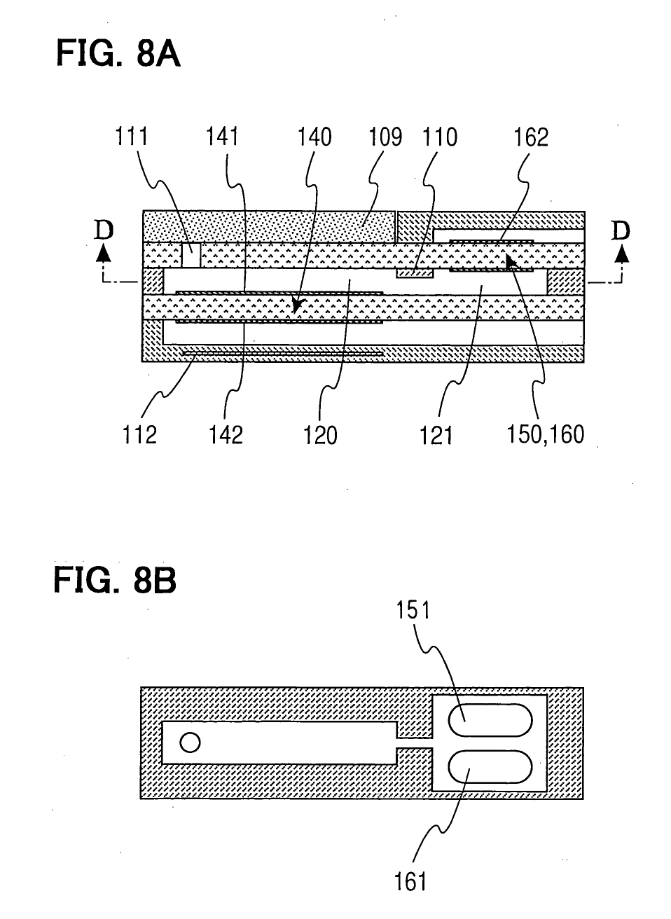

A NOx sensor 101 can have structures other than structure of the first and second embodiments, and can be a structure according to a third embodiment shown in FIGS. 8A, 8B. In the first and second embodiments, a sensor cell 150 and monitor cell 160 are aligned in a longitudinal direction of the sensor element; however, the cells 150, 160 of the third embodiment are disposed to oppose each other in parallel with the longitudinal direction of the sensor element 104. The other structures and basic operation of the third embodiment are the same as that of the first and second embodiments.

A distribution of an oxygen concentration within the second chamber 121 tends to occur along a path which the exhaust gasses travel through, i.e., along a longitudinal direction of the sensor element 104. With respect to the third embodiment, the oxygen concentration on an electrode 151 of the sensor cell 150 is the same that on an electrode 161 of the monitor cell 160 regardless of the distribution of the oxygen concentration. Accordingly, the sensitivities of the sensor and monitor cells 150, 160 with respect to the residual oxygen within the second chamber 121 become the same, enabling highly accurate detection.

In the above first and second embodiments, the NOx sensors detect the NOx from the current output difference between the sensor and monitor cells 150, 160; however, the third embodiment can be directed to other types of the NOx sensor 101.

### Fourth Embodiment

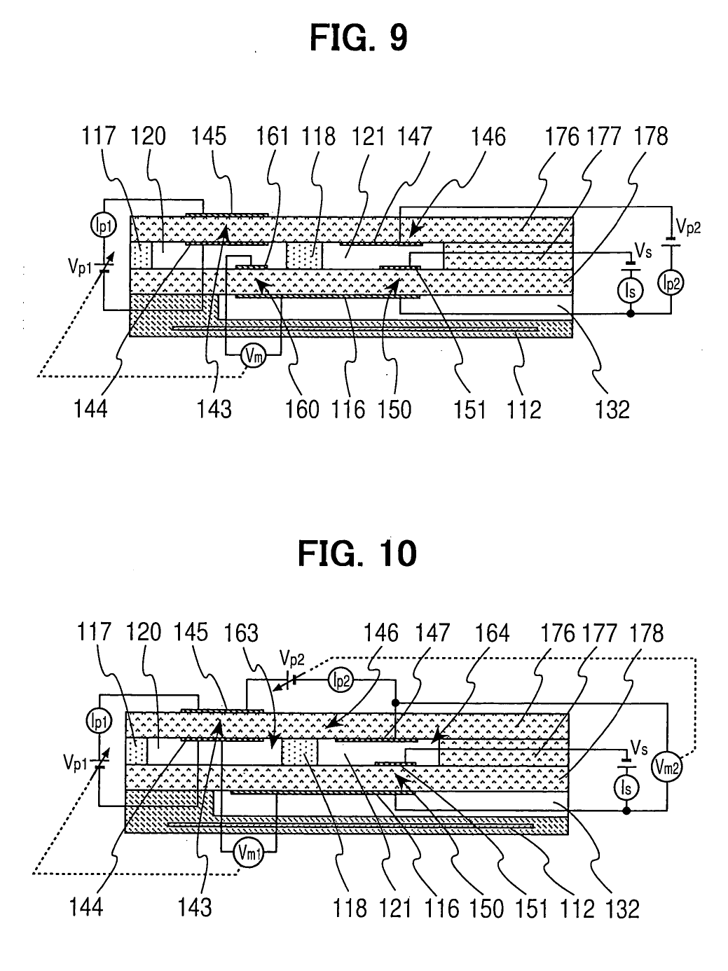

A sensor element 104 according to a fourth embodiment shown in FIG. 9 is a multi-layer structure including solid electrolyte element layers 176, 177, 178 formed of a solid electrolyte element such as zirconia. The sensor element 104 accommodates a first and second chambers 120, 121 into which exhaust gasses are admitted via porous resisting layers 117, 118. The first chamber 120 includes a first pump cell 143 and a monitor cell 160, while the second chamber 121 includes a sensor cell 150 and a second pump cell 146. The first pump cell 143 has an opposing pair of electrodes 144, 145 between which the solid electrolyte element layer 176 is sandwiched. The monitor cell 160 has a pair of electrodes 161, 116 between which the solid electrolyte element layer 178 is sandwiched. The electrode 161 faces an atmosphere duct 132 (atmosphere-side electrode 161), being a common electrode of the sensor cell 150 and the second pump cell 146. The sensor cell 150 has a pair of electrodes 151, 116 between which the solid electrolyte element layer 178 is sandwiched, while the second pump cell 146 has a pair of electrodes 147 formed on a lower surface of the solid electrolyte element layer 176 and the atmosphere-side electrode 116. Furthermore, a heater 112 is provided under the atmosphere duct 132.

In the above structure, the exhaust gasses are admitted into the first chamber 120 via the porous resisting layer 117, while almost all oxygen in the exhaust gasses is discharged into an exhaust side by the first pump cell 143. Here, the oxygen concentration within the first chamber 120 is detected from an electromotive force Vm generated between the electrodes 161, 116 of the monitor cell 160. For this detected concentration to converge into a given value, applied-voltage Vp1 to the first pump cell 143 is controlled, resulting in causing the first chamber 120 to accommodate a low oxygen concentration. The exhaust gasses are further admitted into the second chamber 121 via the porous resisting layer 118, while the residual oxygen in the exhaust gasses are decomposed and discharged into the atmosphere duct 132 by the second pump cell 146. Applied-voltage Vp2 to the second pump cell 146 is controlled according to current Ip2 flowing through the second pump cell 146. NOx is decomposed on the chamber-side electrode 151 and discharged into the atmosphere duct 132 through applying given voltage Vs to the sensor cell 150.

Even in the structure where the applied-voltage Vp1 to the first pump cell 143 is controlled by the voltage output Vm of the monitor cell 160, the element cover 103 indicated in the first and second embodiments can be used to exhibit the same effect. Here, in the fourth embodiment, as explained above, the applied-voltage Vp1 to the first pump cell 143 is controlled by the voltage output Vm of the monitor cell 160, while in the first and second embodiments the NOx concentration is obtained by computing an output difference with the sensor cell 150. However, output characteristics (e.g., O₂ concentration: longitudinal axis, time: lateral axis) of the sensor and monitor cells are similar with that shown in FIGS. 7A to 7C. Namely, the monitor cell has a rapider response characteristic to the oxygen concentration, so that the oxygen concentration within the first chamber 120 fluctuates, leading to possibly affecting the output of the sensor cell 150. Therefore, even in this embodiment, the element cover 103 indicated in the first and second embodiments can exhibit the same effect when it is adopted.

### Fifth Embodiment

A fifth embodiment of the present invention is shown in FIG. 10. A structure of this embodiment is almost the same as that of the fourth embodiment. However, this embodiment is differentiated from the fourth embodiment by having a first monitor cell 163 within a first chamber 120 and a second monitor cell 164 within a second chamber 121. The first monitor cell 163 includes an electrode 144 that is shared by the first pump cell 143 and an atmosphere-side electrode 116. The second monitor cell 164 includes an electrode 147 that is shared by the second pump cell 146 and an atmosphere-side electrode 116.

Here, the oxygen concentration within the first chamber 120 is detected from an electromotive force Vm1 generated between the electrodes 144, 116 of the first monitor cell 163 to control applied-voltage Vp1 to the first pump cell 143. The oxygen concentration within the second chamber 121 is detected from an electromotive force Vm2 generated between the electrodes 147, 116 of the second monitor cell 164 to control applied-voltage Vp2 to the second pump cell 146. Even in this structure, the element cover 103 indicated in the first and second embodiments can exhibit the same effect when it is adopted.

The above embodiments, the present invention is directed to detection of a NOx concentration in exhaust gasses; however, it can be directed to other gas concentration detectors handling gasses other than the NOx. Furthermore, the present invention can be directed not only to an embodiment handling exhaust gasses as measurement gasses from an internal combustion engine, but also to an embodiment handling other measurement gasses.

It will be obvious to those skilled in the art that various changes may be made in the above-described embodiments of the present invention. However, the scope of the present invention should be determined by the following claims.

What is claimed is:

1. A gas concentration detector provided in a space for measuring a concentration of given gas contained in measurement gasses existing within the space, the gas concentration detector comprising:
a sensor element including,
a sensor cell for detecting the concentration of the given gas contained in the measurement gasses that are admitted into a chamber within the sensor element, and
a monitor cell for detecting an O₂ concentration within the chamber; and
an element cover that is a cylinder having a bottom, to surround the sensor element, wherein the element cover has a gas inlet hole through which the measurement gasses flow,
wherein the gas inlet hole includes a plurality of side wall holes and at least one bottom wall hole,
wherein diameters of the side wall holes and the bottom wall hole are within a range between 0.5 and 1.5 mm, and
wherein a ratio of the diameter of the side wall holes to the diameter of the bottom wall hole is within a range between 0.5 and 1.5.

2. The gas concentration detector of claim 1,
wherein the given gas includes NOx, and
wherein the sensor cell includes an electrode that faces the chamber and that is active in decomposing the NOx while the monitor cell includes an electrode that faces the chamber and that is inactive in decomposing the NOx.

3. The gas concentration detector of claim 1,
wherein the plurality of the side wall holes includes four, five, or six side wall holes.

4. The gas concentration detector of claim 3,
wherein all of the plurality of the side wall holes are disposed approximately in a same virtual plane perpendicular to an axis of the cylinder.

5. The gas concentration detector of claim 1, further comprising:
an outer cover surrounding the element cover to form a double structured cover by being combined with the element cover.

6. The gas concentration detector of claim 5,
wherein the outer side wall holes of the outer cover are disposed closer to the bottom of the element cover and the outer bottom of the outer cover than the side wall holes of the element cover.

7. The gas concentration detector of claim 5,
wherein the outer cover has an outer gas inlet hole including at least one outer bottom wall hole, and
wherein a diameter of the outer bottom wall hole of the outer cover is not less than the diameter of the bottom wall hole of the element cover.

8. The gas concentration detector of claim 5,
wherein the outer cover has an outer gas inlet hole including a plurality of outer side wall holes, and
wherein diameters of the outer side wall holes of the outer cover are not less than the diameters of the side wall holes of the element cover.

9. The gas concentration detector of claim 5,
wherein the outer cover has an outer gas inlet hole including a plurality of outer side wall holes and at least one outer bottom wall hole, and
wherein diameters of the outer side wall holes and the outer bottom wall hole of the outer cover are not less than any diameters of the side wall holes and the bottom wall hole of the element cover.

10. The gas concentration detector of claim 1,
wherein the sensor element further includes:
a pump cell for adjusting the O₂ concentration within the chamber by executing at least one of discharging O₂ to an outside and pumping O₂ from the outside.

11. The gas concentration detector of claim 1,
wherein the concentration of the given gas is detected from an output difference between the sensor cell and the monitor cell.

12. The gas concentration detector of claim 1,
wherein the sensor cell and the monitor cell are disposed close to each other within the chamber.

13. The gas concentration detector of claim 1,
wherein the sensor cell includes an electrode formed of Pt—Rh facing the chamber while the monitor cell includes an electrode formed of Pt—Au facing the chamber.
